(19) United States
(12) Patent Application Publication
(10) Pub. No.: US 2026/0066522 A1
(43) Pub. Date: Mar. 5, 2026

(54) ELECTRONIC DEVICE AND CONTROL METHOD

(71) Applicant: Lenovo (Beijing) Limited, Beijing (CN)

(72) Inventor: Kangkang CHEN, Beijing (CN)

(21) Appl. No.: 19/310,182

(22) Filed: Aug. 26, 2025

(30) Foreign Application Priority Data
Aug. 30, 2024 (CN) 202411215096.3

(51) Int. Cl. H01Q 1/22; G01S 13/42; G06F 1/16; H01Q 1/36; H01Q 1/44

(52) U.S. Cl. CPC H01Q 1/2266; G01S 13/42; G06F 1/1656; H01Q 1/364; H01Q 1/44

(57) ABSTRACT

An electronic device includes a frame body and a processing chip. A target member of the frame body is made of metal and used as a frame antenna. The frame antenna is at least capable of transmitting and receiving radiation signals of a target frequency band. A radiation space of the radiation signals transmitted by the frame antenna at least includes a first radiation space located on one side of a first surface of the frame body and a second radiation space located on one side of a second surface of the frame body. The first surface and the second surface are non-intersecting. The target member connects the first surface and the second surface. The processing chip is configured to determine a distance between the target device and the electronic device based on the radiation signals transmitted by the target device received by the frame antenna.

### CROSS-REFERENCES TO RELATED APPLICATION

The present disclosure claims priority to Chinese Patent Application No. 202411215096.3 filed on Aug. 30, 2024, the entire content of which is incorporated herein by reference.

### FIELD OF TECHNOLOGY

The present disclosure relates to the wireless communication technology field and, more particularly, to an electronic device and a control method.

### BACKGROUND

Currently, electronic devices are widely used and have become important tools. With the development of positioning technology and hardware systems, antennas are integrated in the electronic devices for at least ranging purposes, so that the electronic devices can communicate wirelessly with other devices and determine distances of other devices relative to the electronic devices based on the wireless communication status.

### SUMMARY

One aspect of this disclosure provides an electronic device, including a frame body and a processing chip. A target member of the frame body is made of metal and used as a frame antenna. The frame antenna is at least capable of transmitting and receiving radiation signals of a target frequency band. A radiation space of the radiation signals transmitted by the frame antenna at least includes a first radiation space located on one side of a first surface of the frame body and a second radiation space located on one side of a second surface of the frame body. The first surface and the second surface are non-intersecting. The target member connects the first surface and the second surface. The processing chip is configured to determine a distance between the target device and the electronic device based on the radiation signals transmitted by the target device received by the frame antenna.

Another aspect of this disclosure provides a control method of an electronic device. The method includes communicating with a target device, and receiving radiation signals transmitted by the target device through a frame antenna and determining a distance between the target device and the electronic device based on the radiation signals.

### BRIEF DESCRIPTION OF THE DRAWINGS

In combination with accompanying drawings and with reference to the following description of embodiments, the above and other features, advantages, and aspects of the embodiments of the present disclosure will become more apparent. Throughout the drawings, a same or similar reference number represents a same or similar element. It should be understood that the drawings are schematic and that an element is not necessarily drawn to scale.

FIG. 1 is a schematic diagram of an antenna layout of an electronic device according to some embodiments of the present disclosure.

FIG. 2 is a schematic structural diagram of an electronic device according to some embodiments of the present disclosure.

FIG. 3 is a schematic structural diagram of another electronic device according to some embodiments of the present disclosure.

FIG. 4 is a schematic structural diagram of another electronic device according to some embodiments of the present disclosure.

FIG. 5 is a schematic structural diagram of another electronic device according to some embodiments of the present disclosure.

FIG. 6 is a schematic diagram of determining a relative angle between an electronic device and a target device according to some embodiments of the present disclosure.

FIG. 7 is a schematic diagram showing a circuit structure of an electronic device according to some embodiments of the present disclosure.

FIG. 8 is a schematic flowchart of an electronic device control method according to some embodiments of the present disclosure.

Reference numerals:

| | | |
|---|---|---|
| 11 Patch antenna | 12 Frame antenna | 121 First frame antenna |
| 122 Second frame | 13 Frame body | 131 First frame |
| antenna | | |
| 132 Second frame | 14 Processing chip | 15 Target antenna |
| 16 Sensor | | |

### DETAILED DESCRIPTION

Embodiments of the present disclosure are described in detail in connection with the accompanying drawings of embodiments of the present disclosure. Those skilled in the art should understand that, with the development of technology and new scenarios, the technical solution of embodiments of the present disclosure is also suitable for similar technology problems.

Obviously, the described embodiments are merely some embodiments of the present disclosure and not all embodiments. Based on embodiments of the present disclosure, all other embodiments obtained by those of ordinary skill in the art without creative efforts shall fall within the scope of the present disclosure. The terms used in embodiments of the present disclosure are merely used to describe, not limit, embodiments of the present disclosure.

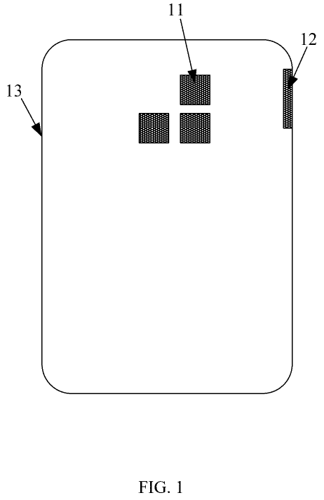

Applicants found that, when an electronic device positions another device, a plurality of antennas are needed. FIG. 1 shows an antenna layout of the electronic device.

FIG. 1 is a schematic diagram of an antenna layout of an electronic device according to some embodiments of the present disclosure. The electronic device includes at least 3 patch antennas 11 and one frame antenna 12. The patch antennas 11 are disposed in an internal space of the electronic device enclosed by the frame body 13 of the electronic device. The frame antenna 12 is formed by a part of the frame body 13.

The patch antennas 11 and the frame antenna 12 can be Ultra Wide Band (UWB) antennas. The patch antennas 11 can be configured to receive and send a high-frequency signal to determine a positioning capability with an accuracy. The frame antenna 12 can be configured to enhance signal coverage and improve signal quality to improve the positioning accuracy.

When the electronic device positions another device, a distance between another device to the electronic device can be at least determined. Further, to realize more accurate positioning, the angle of another device relative to the electronic device may need to be determined.

Three patch antennas 11 can include a first patch antenna, a second patch antenna, and a third patch antenna. The electronic device shown in FIG. 1 is able to perform distance measurement based on Time of Flight (ToF) technology. UWB technology can use narrow pulse signals for short-range high-precision wireless communication. The signals can have good time resolution, which makes the ToF technology possible. In ToF distance measurement, the patch antenna 11 of the electronic device can emit a pulse signal, and another device in wireless communication with the electronic device can record the arrival time of the signal. Since the signal propagation speed in air is known (equivalent to the speed of light), by measuring the time of flight of the signal, the distance between the electronic device and another device can be calculated.

The electronic device shown in FIG. 1 is able to perform positioning based on Phase Difference of antenna (PDOA) technology. The PDOA technology can accurately determine the direction of the signal source by precisely measuring the phase difference of the signals received by different patch antennas 11. In PDOA technology, by comparing the phase differences of the signals received by the different patch antennas 11, the arrival angle of the signal can be calculated. The measurement of the phase difference may require the reception links corresponding to the two antennas to belong to the same clock source.

The first patch antenna and the second patch antenna can be configured for vertical angle measurement. The second patch antenna and the third patch antenna can be configured for horizontal angle measurement to determine the relative angle between the electronic device and another device. Based on the angles measured by the three patch antennas, the angle between another device relative to the electronic device can be determined.

Based on the above, when the electronic device performs positioning on another device based on the patch antennas 11, many antennas are needed. In addition, the PDOA technology can impose strict requirements on the distance parameters between two neighboring patch antennas 11. The distance between the two antennas may need to satisfy the half-wavelength distance, and the impact of mutual coupling between antennas on positioning results may also be considered. For small mobile terminals such as mobile phones and wearable devices, the limited internal layout space of the device can be difficult to meet the antenna layout requirements of the PDOA technology.

Embodiments of the present disclosure provide an electronic device, including a frame body and a processing chip.

A target member of the frame body can be metal. The target member can be used as a frame antenna. The frame antenna can at least receive and send a radiation signal of a target frequency band. The radiation space of the radiation signal transmitted by the frame antenna can at least include a first radiation space on one side of the first surface of the frame body and a second radiation space on one side of the second surface of the frame body. The first surface and the second surface may not intersect. The target member can connect the first surface and the second surface.

The processing chip can be configured to receive the radiation signal transmitted by the target device based on the frame antenna.

The processing chip can be configured to at least determine the distance between the electronic device and the target device based on the radiation signal.

The electronic device of embodiments of the present disclosure can perform wireless communication with the target device based on the target member of the frame body as the frame antenna to determine the distance between the target device and the electronic device. Thus, the electronic device can realize wireless communication with the target device (e.g., another device). The electronic device can also measure the distance of the target device relative to the electronic device to solve the existing technical problem.

Moreover, the radiation signal transmitted by the frame antenna formed based on the target member of the frame body can make the radiation space of the radiation signal at least include the first radiation space on one side of the first surface of the frame body and the second radiation space on one side of the second surface of the frame body to reduce the self-blocking of the electronic device to the radiation space. Thus, the distance measurement of the target device by the electronic device may not be limited by the application posture of the electronic device.

Further, in some embodiments, the processing chip can be configured to determine the angle of the target device relative to the electronic device based on the radiation signals received and transmitted by the electronic device based on the frame antenna at different positions. Combined with the distance between the target device and the electronic device, more accurate positioning can be achieved.

The present disclosure can be further described in detail in connection with the accompanying drawings and specific embodiments.

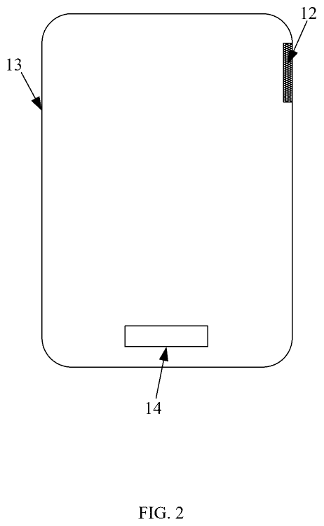

FIG. 2 is a schematic structural diagram of an electronic device according to some embodiments of the present disclosure. The electronic device includes a frame body 13 and a processing chip 14.

The target member of the frame body 13 is made of metal. The target member can be used as a frame antenna 12. The frame antenna 12 can at least receive and transmit radiation signals of a target frequency band. The radiation space of the frame antenna 12 transmitting the radiation signals can include a first radiation space on one side of the first surface of the frame body 13 and a second radiation space on one side of the second surface of the frame body 13. The first surface and the second surface may not intersect. The target member can connect the first surface and the second surface.

The processing chip 14 can receive the radiation signal transmitted by the target device based on the frame antenna 12.

The processing chip 14 can at least determine the distance between the electronic device and the target device based on the radiation signal.

The frame antenna 12 can be a part of the visible outer frame of the electronic device. Then, the frame antenna 12 can be located outside the electronic device and can be visible. In some other embodiments, the frame antenna 12 can be located inside the frame body 13, e.g., being injection-molded inside the frame body.

In some embodiments, the target frequency band can be 3.1 GHz to 10.6 GHz. Then, the frame antenna 12 can be a UWB antenna, and the target frequency band can be a UWB frequency band. The electronic device can perform wireless communication with the target device based on the UWB technology.

In the electronic device of embodiments of the present disclosure, the target member of the frame body 13 can be used as the frame antenna 12. The frame antenna 12 can be configured for wireless communication with the target device to determine the distance between the target device and the electronic device. Therefore, the electronic device can achieve wireless communication with the target device and measure the distance of the target device relative to the electronic device.

Moreover, the radiation signal transmitted by the frame antenna 12 formed based on the target member of the frame body 13 can make the radiation space of the radiation signal at least include the first radiation space on one side of the first surface of the frame body 13 and the second radiation space on one side of the second surface of the frame body. Thus, the self-blocking of the electronic device to the radiation space can be reduced, and the distance measurement performed by the electronic device on the target device may not be limited by the application posture of the electronic device.

The first surface can be the front surface of the electronic device, and the second surface can be the back surface of the electronic device. For example, if the electronic device is a mobile phone, the first surface can be the display surface of the phone, and the second surface can be the outer surface of the back cover of the phone.

For example, if the mobile phone performs the distance measurement based on a patch antenna 11 located on the back surface of the display, the back surface of the phone may need to be ensured to face the target device to avoid the display blocking the patch antenna 11 and affecting the distance measurement result. When the phone performs the distance measurement on the target device based on the radiation signal transmitted based on the frame antenna 12, since the radiation space of the radiation signal includes the first radiation space and the second radiation space, the frame antenna 12 may not be blocked by the display of the phone, the posture of the phone during distance measurement may not be limited, and the phone can be conveniently used compared to the solution of distance measurement based on the patch antenna 11 located on the back surface of the display.

In some embodiments of the present disclosure, the electronic device can perform wireless communication with the target device only through the frame antenna 12 and determine the distance of the target device relative to the electronic device only based on the radiation signals transmitted and received by the frame antenna 12. Based on this, the angle of the target device relative to the electronic device can also be measured only based on the radiation signals transmitted and received by the frame antenna 12.

As described below, in some other embodiments, the electronic device can also perform the wireless communication with the target device through one patch antenna 11 and the frame antenna 12, and determine the distance of the target device relative to the electronic device based on the radiation signals transmitted and received by the patch antenna 11 and the radiation signals received by the frame antenna 12. Based on this, the angle of the target device relative to the electronic device can also be measured based on the radiation signals transmitted and received by the patch antenna 11 and the radiation signals received by the frame antenna 12.

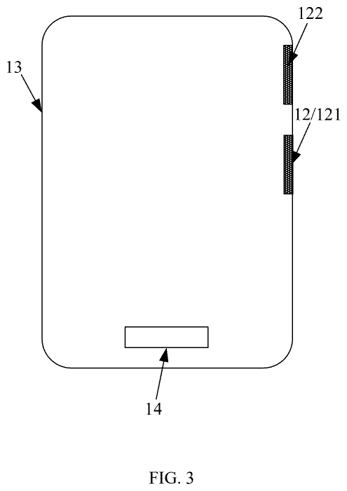

FIG. 3 is a schematic structural diagram of another electronic device according to some embodiments of the present disclosure. The target member includes a first target member and a second target member. The first target member is a first frame antenna 121, and the second target member is a second frame antenna 122. In some embodiments, the first target member and the second target member are located on the same frame.

If the frame body 13 is polygonal, in embodiments of FIG. 3, the two target members are located on any side of the frame body 13.

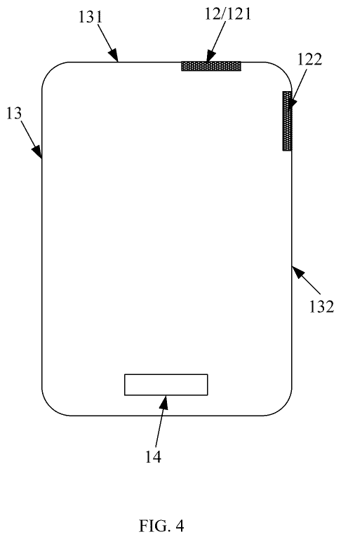

FIG. 4 is a schematic structural diagram of another electronic device according to some embodiments of the present disclosure. Consistent with embodiments of FIG. 3, in embodiments of FIG. 4, a target member includes a first target member and a second target member. The first target member is a first frame antenna 121, and the second target member is a second frame antenna 122. The difference from FIG. 3 includes that, in embodiments of FIG. 4, the first target member is located on a first frame 131, and the second target member is located on a second frame 132. The first frame 131 and the second frame 132 intersect.

In embodiments shown in FIGS. 3 and 4, the first target member and the second target member are two different local members of the frame body 13, which are used as the first frame antenna 121 and the second frame antenna 122, respectively. Thus, with the only two frame antennas 12, the electronic device can perform distance and angle measurement on the target device.

When the electronic device performs wireless communication with the target device based on the two frame antennas 12, and measures the distance to the target device based on the radiation signals transmitted and received by the frame antennas 12, the distance and angle of the target device can be measured more accurately based on the radiation signals received by the two frame antennas 12.

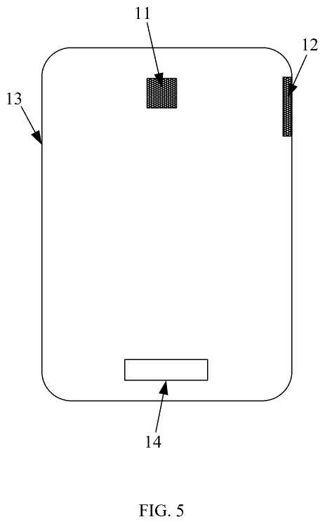

FIG. 5 is a schematic structural diagram of another electronic device according to some embodiments of the present disclosure. The electronic device of FIG. 5 further includes a metal sheet used as a patch antenna 11, which is located in an accommodation space of the frame body 13. The accommodation space is on the side of the second surface of the frame body. The patch antenna 11 can be configured to transmit and receive radiation signals.

In some embodiments, the metal sheet can be rectangular, circular, elliptical, or other polygonal structures, which is not limited in embodiments of the present disclosure.

For example, as shown in FIG. 5, the electronic device includes one frame antenna 12 and one patch antenna 11. In other embodiments, the electronic device can also include two frame antennas 12 and one patch antenna 11.

The accommodation space can also include a metal structure on the side of the patch antenna 11 facing the first surface. The metal structure can include a display screen and/or a battery. The patch antenna 11 is not blocked by a metal structure on the side facing the second surface, but is blocked by the metal structure on the side facing the first surface. Due to the blocking of the metal structure, the radiation space of the patch antenna 11 can be the space on the side of the second surface of the electronic device. The radiation space of the patch antenna 11 can be equivalent to the second radiation space of the frame antenna 12.

Compared with the frame antenna 12, although the omnidirectionality of the patch antenna 11 is relatively poor, the patch antenna 11 can be formed by using ceramic or other dielectric materials as the substrate, which allows the patch antenna 11 to have a higher operation frequency, and to be configured to transmit and receive high-frequency signals. Thus, the patch antenna 11 can have good directivity and high-frequency characteristics. Additionally, the patch antenna 11 can have a longer effective communication distance compared to the frame antenna 12.

In embodiments of the present disclosure, based on the above, positioning the target device by the electronic device can include measuring the distance of the target device relative to the electronic device, or measuring the distance and the angle of the target device relative to the electronic device. When positioning the target device based on the electronic device, an authenticated wireless communication connection may need to be first established between the electronic device and the target device.

The electronic device can at least include a first mode. In the first mode, the processing chip 14 can communicate with the target device wirelessly by controlling the frame antenna 12 to transmit and receive the radiation signals. The processing chip 14 can also be configured to measure the distance of the target device based on the radiation signals received by the frame antenna 12.

In the first mode, the distance of the target device relative to the electronic device can be determined based on the radiation signals transmitted and received by a single frame antenna 12. The electronic device can measure the distance by using the ToF (Time of Flight) technology. In some embodiments, a first radiation signal can be transmitted to the target device via one frame antenna 12, the target device can receive the first radiation signal and record the time, then send a second radiation signal back to the electronic device, and the electronic device can receive the second radiation signal and record the time. The electronic device can obtain the transmission time of the radiation signal based on the wireless communication relationship with the target device to determine the time of flight of the radiation signal between the electronic device and the target device. The product of the time and the speed of light can be used as the distance between the target device and the electronic device.

In the first mode, if the radiation signal is able to be transmitted and received by a single frame antenna 12, the distance to the target device can be determined based on the radiation signal received by the frame antenna 12.

In some other embodiments, the radiation signal can be transmitted and received by one frame antenna 12, and the radiation signal can be received by another frame antenna 12. Based on the radiation signals received by the two frame antennas 12, the distance to the target device can be determined. Then, the processing chip 14 can receive the radiation signals by the two frame antennas 12 to measure the distance to the target device. Based on the strengths of the radiation signals received by the two frame antennas 12 from the target device, a host antenna and an auxiliary antenna can be determined from the two frame antennas 12. The host antenna can transmit and receive the radiation signals with the target device. The auxiliary antenna can only receive the radiation signal from the target device and cannot transmit the radiation signal. The radiation signals received by the two frame antennas 12 of the electronic device can be processed. The signal processing can include amplification processing and frequency processing. The processed signals can then be combined to obtain a final signal with a high signal-to-noise ratio (SNR). In some embodiments, a weighted sum can be performed based on the SNRs of the signals to obtain the final signal with the high SNR to determine the distance to the target device.

In some embodiments, when the two frame antennas 12 collect the radiation signals of the target device, the processing chip 14 can dynamically select a frame antenna 12 having a strong ability to receive the radiation signal as the host antenna based on the current communication environment, and select the other antenna as the auxiliary antenna.

In some embodiments, in the first mode, the processing chip 14 can also determine the angle of the target device relative to the electronic device based on the radiation signals transmitted and received by the frame antenna 12 when the electronic device is at different positions. Based on the above, the radiation signals can be transmitted and received based on one frame antenna 12, and the angle can be determined based on the received radiation signals received by the frame antenna 12. In some other embodiments, the radiation signals can be received by the two frame antennas to determine the angle of the final signal with the high signal-to-noise ratio.

In embodiments of the present disclosure, the processing chip 14 can, in the first mode, control the frame antenna 12 to transmit the radiation signals to the target device. The radiation signals transmitted by the target device can be received by the frame antenna 12. Based on the radiation signals received by the frame antenna 12, the angle of the target device relative to the electronic device can be determined. Based on the above, based on the radiation signals transmitted and received by the frame antenna 12 and the ToF technology, the distance between the target device and the electronic device can be determined. Further, the processing chip 14 can also determine the angle of the target device relative to the electronic device based on the radiation signals transmitted and received by the frame antenna 12 when the electronic device is at different positions.

By changing the position of the electronic device, the distances between the electronic device at different positions and the target device can be determined, and the distances between the different positions where the electronic device is based on the radiation signals received by the frame antenna 12. The angle of the target device relative to the electronic device can be determined based on the principle of triangulation.

The processing chip 14 can determine the angle of the target device relative to the electronic device based on the radiation signals transmitted and received by the frame antenna 12 when the electronic device is at different positions. Then, the angle of the target device relative to the electronic device can be determined only through the frame antenna 12 without the patch antenna 11.

The electronic device can include a patch antenna 11, and the electronic device can further include a second mode. The processing chip 14 can, in the second mode, control the patch antenna 11 to transmit the radiation signals to the target device, and can also receive the radiation signals transmitted by the target device through the frame antenna 12 and the patch antenna 11. Based on the received radiation signals, the angle of the target device relative to the electronic device can be determined.

In the second mode, the patch antenna 11 can be used as the host antenna. Thus, the patch antenna 11 can transmit a radio frequency signal to the target device and receive the RF signal transmitted by the target device. One or two frame antennas 12 can be used as the auxiliary antenna. The frame antenna 12 can only receive the RF signal transmitted by the target device and does not transmit the RF signal to the target device. In this method, through the radiation signals of the target device received by the antenna, the distance and the angle of the target device can be determined.

In the second mode, the processing chip 14 can determine the distance to the target device based on the radiation signals received by the patch antenna 11, which has the same principle as the above ToF measurement method.

Alternatively, in the second mode, the processing chip 14 can use the patch antenna 11 as the host antenna and one or two frame antennas 12 as the auxiliary antenna to receive the radiation signals of the target device through the antennas and determine the distance of the target device based on the radiation signals received by the patch antenna 11 and the frame antenna 12. In this method, signal processing can be performed on the radiation signals received by different antennas. The signal processing can include the amplification processing and the frequency processing. The processed signals can be combined to obtain the final signal with a high signal-to-noise ratio. In some embodiments, the weighted sum can be performed according to the signal-to-noise ratios of the signals, and the obtained final signal with the high signal-to-noise ratio can be used to determine the distance of the target device.

In some embodiments, in the second mode, the processing chip 14 can further determine the angle of the target device based on the radiation signals received by the patch antenna 11, or based on the radiation signals received by the patch antenna 11 and the frame antenna 12.

If the target device and the electronic device have a horizontal distance, as mentioned above, if the electronic device communicates wirelessly with the target device to determine the distance and/or the angle of the target device, the radiation space/radiation direction of the patch antenna 11 may need to face the target device. Thus, in the second mode, the electronic device may need to have an angle with the horizontal plane to cause the second surface to face the target device.

When the target device and the electronic device has the horizontal distance, if the electronic device is parallel to the horizontal plane, the processing chip 14 can, in the first mode, control the frame antenna 12 to transmit the radiation signals to the target device, and can also receive the radiation signals transmitted by the target device through the frame antenna 12. Based on the radiation signals received by the frame antenna 12, the angle of the target device relative to the electronic device can be determined.

When the target device and the electronic device have a horizontal distance, since the radiation space/radiation direction of the patch antenna 11 does not face the target device, the target device cannot be accurately positioned by using the patch antenna 11 to transmit and receive the radiation signals. Then, the target device can be accurately positioned by using the frame antenna 12 with good omnidirectionality to transmit and receive the radiation signals.

In some embodiments, if the electronic device has the patch antenna 11, and the electronic device includes an attitude sensor, whether the electronic device satisfies a parallel condition with the horizontal plane can be detected. If the electronic device satisfies the parallel condition, the electronic device can be controlled to be in the first mode. If the electronic device does not satisfy the parallel condition, the electronic device can be controlled to be in the second mode.

Based on the above description, in the first mode, the electronic device may not include the patch antenna 11. The electronic device can communicate wirelessly with the target device based on one or two frame antennas 12. Based on the radiation signals received by the frame antenna 12, the target device can be positioned to determine the distance and/or the angle of the target device.

In the second mode, the electronic device can wirelessly communicate with the target device only based on one patch antenna 11. The target device can be positioned based on the radiation signals received by the frame antenna 12 to determine the distance and/or the angle of the target device. In some other embodiments, the electronic device can communicate wirelessly with the target device based on the patch antenna 11 and one or two frame antennas 12. The target device can be positioned based on the radiation signals received by the patch antenna 11 and the frame antenna 12 to determine the distance and/or the angle of the target device.

The processing chip 14 can perform positioning on the target device based on the radiation signals received by the frame antenna 12, perform positioning on the target device based on the radiation signals received by the patch antenna 11, or perform positioning on the target device based on the radiation signals received by the patch antenna 11 and the frame antenna 12.

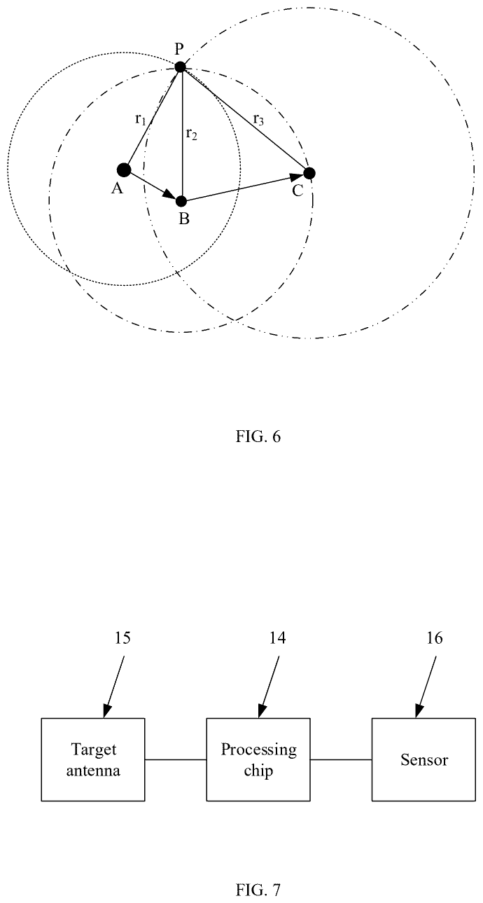

When the target device is positioned based on the radiation signals, if only the distance of the target device is determined, the distance can be measured based on the ToF technology in the first mode and the second mode. The ToF between the electronic device and the target device can be determined through the radiation signals. The distance of the target device can be determined based on the ToF and the speed of light. If the angle of the target device is determined based on the radiation signals, the calculation of the angle is shown in FIG. 6.

FIG. 6 is a schematic diagram of determining a relative angle between an electronic device and a target device according to some embodiments of the present disclosure. At least three different moments, the processing chip 14 can determine the angle of the target device relative to the electronic device based on the radiation signals transmitted and received by the frame antenna 12 and/or the patch antenna 11 when the electronic device is at different positions.

At the first moment, the electronic device can be at the first position A and have a distance PA to the target device. At the second moment, the electronic device can be at the second position B and have a distance PB to the target device. At the third moment, the electronic device can be at the third position C and have a distance PC to the target device.

The processing chip 14 can determine the distance between the electronic device and the target device at different positions based on the radiation signals received by the target antenna in the electronic device. That is, the distances PA, PB, and PC can be determined. The lengths of PA, PB, and PC can be set to r1, r2, and r3, respectively. Position P of the target device can be on a first circle centered at A with radius r1 (dashed circle in FIG. 6), on a second circle centered at B with radius r2 (dotted circle in FIG. 6), and on a third circle centered at C with radius r3 (double-dotted circle in FIG. 6). In the first mode, the target antenna can be the frame antenna 12. In the second mode, the target antenna can be the patch antenna 11, or the target antenna can be the patch antenna 11 and the frame antenna 12.

The coordinates of point A can be set to (x1, y1), the coordinates of point B can be set to (x2, y2), and the coordinates of point C can be set to (x3, y3). That is, the electronic device can determine first position A, second position B, and third position C. (x1, y1), (x2, y2), and (x3, y3) can be three determined coordinate points. The electronic device can determine the position at different times based on the sensor of the electronic device.

The coordinates of point P can be (x, y). Points A, B, and C can be known reference points for point P. Based on the Euclidean distance formula, the following formula group (1) can be established:

$$\{ \begin{matrix}{( x - {x}_{1} )}^{2} + {( y - {y}_{1} )}^{2} = {r}_{1}^{2} \\ {( x - {x}_{2} )}^{2} + {( y - {y}_{2} )}^{2} = {r}_{2}^{2} \\ {( x - {x}_{3} )}^{2} + {( y - {y}_{3} )}^{2} = {r}_{3}^{2}\end{matrix} \qquad ( 1 )$$

The three equations in the above formula group (1) can be expanded to obtain the following formula group (2):

$$\{ \begin{matrix}{x}^{2} - 2 {x}_{1} x + {x}_{1}^{2} + {y}^{2} - 2 {y}_{1} y + {y}_{{1}^{2}} = {r}_{1}^{2} \\ {x}^{2} - 2 {x}_{2} x + {x}_{2}^{2} + {y}^{2} - 2 {y}_{2} y + {y}_{2}^{2} = {r}_{2}^{2} \\ {x}^{2} - 2 {x}_{3} x + {x}_{3}^{2} + {y}^{2} - 2 {y}_{3} y + {y}_{{3}^{2}} = {r}_{3}^{2}\end{matrix} \qquad ( 2 )$$

The three equations in the above formula group (2) can be subtracted pairwise to eliminate x2 and y2 to obtain the following formula group (3):

$$\{ \begin{matrix}- 2 {x}_{1} x + 2 {x}_{2} x - 2 {y}_{1} y + 2 {y}_{2} y = {r}_{1}^{2} - {r}_{2}^{2} - {x}_{1}^{2} + {x}_{2}^{2} - {y}_{1}^{2} + {y}_{2}^{2} \\ - 2 {x}_{2} x + 2 {x}_{3} x - 2 {y}_{2} y + 2 {y}_{3} y = {r}_{2}^{2} - {r}_{3}^{2} - {x}_{2}^{2} + {x}_{3}^{2} - {y}_{2}^{2} + {y}_{3}^{2}\end{matrix} \qquad ( 3 )$$

Constants a, b, c, d, e, and f can be set as follows:

$$a = - 2 x 1 + 2 x 2 ;$$

$$b = - 2 y 1 + 2 y 2 ;$$

$$c = r {1}^{2} - r {2}^{2} - x {1}^{2} + x {2}^{2} - y {1}^{2} + y {2}^{2} ;$$

$$d = - 2 x 2 + 2 x 3 ;$$

$$e = - 2 y 2 + 2 y 3 ; and$$

$$f = r {2}^{2} - r {3}^{2} - x {2}^{2} + x {3}^{2} - y {2}^{2} + y {3}^{2} .$$

Then, the formula group (3) can be represented as the following linear formula group:

$$ax + by = c ; and$$

$$dx + ey = f .$$

Based on the linear algebraic computation methods, such as matrix operations or direct solving, the values of x and y in the above linear formula group can be obtained:

$$x = \frac{c e - fb}{e a - b d} ; and$$

$$y = \frac{cd - af}{b d - a e} .$$

Thus, the coordinates (x, y) of the target position point P can be determined. Once the coordinates of point P are determined, the distance and the angle relative to the current position C of the electronic device can be determined based on the coordinates of point P and point C.

The positioning of FIG. 6 includes positioning based on time anchor points. The electronic device can determine the coordinates of point A, point B, and point C, respectively, in sequence at different moments. At different positions, the distance between the electronic device and the target device can be determined based on the above ToF method. Point A, point B, and point C can be used as the three reference points of point P, and the position of point P can be accurately determined.

From the first moment to the second moment, the electronic device can determine the motion parameters from point A to point B based on the sensor of the electronic device. From the second moment to the third moment, the electronic device can determine the motion parameters from point B to point C based on the sensor of the electronic device to determine the coordinates of the positions corresponding to different moments, and determine the position parameters of the positions. With the coordinates of the positions and the distances between different positions and the target device, the coordinates of the position P of the target device can be determined based on the above calculation method to determine the distance and/or the angle of the target device.

Based on the above description, in embodiments of the present disclosure, in the first mode, the distance and/or the angle of the target device can be determined based on one or two frame antennas 12. In this method, the target device can be positioned without the patch antenna 11. In the second mode, the distance and/or the angle of the target device can be determined based on one patch antenna 11, or the one patch antenna 11 and the frame antenna 12. In some other embodiments, the distance and/or the angle of the target device can be determined according to the one patch antenna 11 and two frame antennas 12. The method may need at most one patch antenna 11, and the three patch antennas 11 may not need to be used to position the target device.

In embodiments of the present disclosure, in the first mode, the distance and/or the angle of the target device can be determined based on one or two frame antennas 12. In this method, the target device can be positioned without the patch antenna 11. In the second mode, the distance and/or the angle of the target device can be determined based on one patch antenna 11, or the one patch antenna 11 and one frame antenna 12. In some other embodiments, the distance and/or the angle of the target device can be determined based on the one patch antenna 11 and the two frame antennas 12. The method can include at most one patch antenna 11, and the three patch antennas 11 may not need to be used to position the target device.

In embodiments of the present disclosure, no or at most one patch antenna 11 may be used to position the target device to greatly reduce the number of patch antennas 11 needed for positioning the target device to save the layout space of the patch antenna 11 of the electronic device. Thus, the electronic device can be miniaturized, and meanwhile, the coupling problem between different patch antennas 11 in the existing positioning solution of the plurality of patch antennas 11 can be avoided.

In the first mode, the electronic device can position the target device through the frame antenna 12 in the flat status (e.g., the electronic device being parallel or nearly parallel to the horizontal plane) or in the non-flat status (e.g., the electronic device having an angle with the horizontal plane). Determining the target device may not be limited to the application attitude of the electronic device, which facilitates the electronic device to use. In the second mode, the electronic device can be in the non-flat status to allow the patch antenna 11 to transmit and receive the radiation signals to position the target device.

For example, the electronic device can be a cell phone. The radiation performances on the back side and front side of the cell phone can be ensured based on the frame antenna 12. The radiation performance of the back side can be ensured based on the patch antenna 11. When the cell phone is used to position the target device, if the frame antenna 12 is used individually, since the frame antenna 12 has a good omnidirectional performance, when the cell phone is in a horizontal status, a vertical status, or an intermediate status between the horizontal status and the vertical status, the target device can be positioned. If the patch antenna 11 is used to position the target device, the cell phone may need to have a certain tilt angle. That is, the cell phone may need to be in the vertical status, or the intermediate status between the horizontal status and the vertical status.

The electronic device can also be a smart car key, which can be used to position a vehicle in the communication range with the vehicle to automatically control the vehicle.

The electronic device can also be configured to position an indoor target device and intelligently control the target device according to the positioning result.

In embodiments of the present disclosure, the electronic device may not be limited to the cell phone, and can be another electronic device, e.g., smart wearable devices, tablet computers, etc. The type and application field of the electronic device may not be limited by embodiments of the present disclosure.

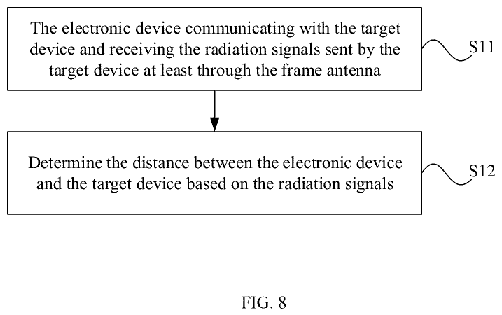

FIG. 7 is a schematic diagram showing a circuit structure of an electronic device according to some embodiments of the present disclosure. The electronic device further includes a sensor 16 configured to detect the movement of the electronic device. The processing chip 14 is connected to the target antenna 15 and the sensor 16. The target antenna 15 includes the patch antenna 11 and/or the frame antenna 12.

The processing chip 14 can determine the angle of the target device relative to the electronic device based on the motion parameters obtained by the sensor 16 and the distance between the electronic device and the target device. In some embodiments, the sensor 16 can detect the motion parameters of the electronic device moving from one position to another. The processing chip 14 can determine the position coordinates of the electronic device at different positions based on the motion parameters. Based on the position coordinates of different positions and the distances to the target device at different positions, the processing chip 14 can position the target device through the principle of FIG. 6 to determine the distance and/or the angle of the target device.

As described above, the processing chip 14 can be used to determine the coordinates of the electronic device at different positions based on the motion parameters. Based on the coordinates of different positions and the distances between the electronic device at different positions and the target device, the angle of the target device relative to the electronic device can be determined through the principle of FIG. 6.

In some embodiments, the sensor 16 can include an IMU (Inertial Measurement Unit). The IMU can usually include a triaxial accelerometer, a triaxial gyroscope, and a triaxial magnetometer, which can improve the detection of the 9-axis motion parameters. To further improve positioning accuracy, the sensor 16 can also include a machine vision assembly (Vision). The machine vision assembly can be configured to capture, process, and analyze the image to allow the electronic device to realize the automatic visual recognition and detection functions.

In embodiments of the present disclosure, the antennas can be an antenna that supports UWB communication.

When an existing electronic device performs positioning based on the UWB technology, the three patch antennas 11 and the one frame antenna 12 may be needed to realize the core positioning functions of measuring the distance and the angle. A large number of antennas may need a large layout space, which directly affects the stacking and appearance design of the whole device.

In embodiments of the present disclosure, no or only one patch antenna 11 may be needed to realize the distance measurement function and the angle measurement function to greatly reduce the number of patch antennas 11.

In addition, in embodiments of the present disclosure, based on the reflection characteristics of a non-source object to the radiation signals of the electronic device, the electronic device can detect the radiation signals reflected by the non-source object to realize the radar object detection function.

Based on the above, embodiments of the present disclosure further provide a control method of the electronic device. The control method can be applied to the electronic device above. The control method is shown in FIG. 8.

FIG. 8 is a schematic flowchart of a control method of an electronic device according to some embodiments of the present disclosure. The control method includes the following steps.

At S11, the electronic device communicates with the target device and receives the radiation signals sent by the target device at least through the frame antenna.

At S12, the distance between the electronic device and the target device is determined based on the radiation signals.

Based on the above, the electronic device can execute the control method based on the processing chip 14. The distance to the target device can be measured based on the radiation signals received by the target antenna in the electronic device.

In some embodiments, the control method can include, in the first mode, controlling the frame antenna to transmit the radiation signals to the target device, receive the radiation signals transmitted by the target device through the frame antenna, and determine the angle of the target device relative to the electronic device based on the received radiation signals, and/or, the electronic device further including a metal sheet as the patch antenna, the metal sheet being rectangular and located in the accommodation space of the frame body, the accommodation space being located on one side of the second surface of the frame body, in the second mode, controlling the patch antenna to transmit the radiation signals to the target device, receiving the radiation signals transmitted by the target device through the frame antenna and the patch antenna, and determining the angle of the target device relative to the electronic device based on the received radiation signals.

In the first mode and the second mode, for the principle of the distance measurement and the angle measurement of the electronic device, reference can be made to the description above, which is not repeated here.

Through the above description, in embodiments of the present disclosure, the electronic device can receive the radiation signals from the target device through the target antenna to position the target device. At most, one patch antenna 11 may be needed, which can greatly reduce the number of required patch antennas 11.

Embodiments of the present disclosure are described in a progressive manner, a parallel manner, or a combined manner thereof. Each embodiment focuses on the differences from other embodiments, and the same or similar parts among various embodiments can be referred to each other. Embodiments of the present disclosure can be combined with each other as long as there is no conflict.

In the description of the present disclosure, the accompanying drawings and embodiments are illustrative rather than restrictive. The same reference numerals throughout embodiments of the present disclosure can indicate the same structure. Additionally, to facilitate understanding and description, the accompanying drawings may exaggerate the thickness of some layers, films, panels, or regions. When elements such as layers, films, regions, or substrates are referred to as being on another element, the element can be directly on the other element, or an intermediate element may exist in between. Furthermore, “on” refers to placing an element above or below another element, but does not inherently indicate a position above the other element in the direction of gravity.

The orientation or positional relationships indicated by terms, such as “up,” “below,” “top,” “bottom,” “inner,” “outer,” etc., are based on the orientation or positional relationships shown in the drawings, and are only used to facilitate the description of the present disclosure and simplify the description, rather than indicating or implying that the referred apparatus or element must have a specific orientation, and be constructed and operated in a specific orientation, which should not be understood as limiting the present disclosure. When an assembly is considered to be connected to another assembly, the assembly can be directly connected to another assembly, or an intermediate assembly may exist.

In the present specification, the relational terms such as first and second can only be used to distinguish one entity or operation from another entity or operation, and do not necessarily require or imply any actual relationship or order between these entities or operations. Also, the terms “comprises,” “includes,” or any of variants of them are intended to cover non-exclusive inclusion, so that an article or device that includes a set of elements not only includes those elements but may also include other elements not expressly listed, or may also include elements inherent to such an article or device. Without further limitation, an element defined by the phrase “comprising a . . . ” does not exclude the existence of additional identical elements in an article or device that includes the element.

The above description of embodiments of the present disclosure can enable those skilled in the art to implement or use the present disclosure. Various modifications to the embodiments will be apparent to those skilled in the art, and the general principles defined here can be applied to other embodiments without departing from the spirit or scope of the present disclosure. Thus, the present disclosure is not limited to the embodiments described here, but conforms to the widest scope consistent with the principles and novel features of the present disclosure.

What is claimed is:

1. An electronic device comprising:
a frame body, a target member of the frame body being metal and used as a frame antenna, the frame antenna at least being capable of transmitting and receiving radiation signals of a target frequency band, a radiation space of the radiation signals transmitted by the frame antenna at least including a first radiation space located on one side of a first surface of the frame body and a second radiation space located on one side of a second surface of the frame body, the first surface and the second surface being non-intersecting, and the target member connecting the first surface and the second surface; and
a processing chip configured to determine a distance between a target device and the electronic device based on the radiation signals transmitted by the target device and received by the frame antenna.

2. The electronic device according to claim 1, wherein:
the target member includes a first target member and a second target member, the first target member being a first frame antenna, and the second target member being a second frame antenna; and
a relative positional relationship between the first target member and the second target member includes one of:
the first target member and the second target member being located on a same frame; and
the first target member being located on a first frame, the second target member being located on a second frame, and the first frame intersecting with the second frame.

3. The electronic device according to claim 1, further comprising:
a metal sheet used as a patch antenna, located in an accommodation space of the frame body, and the accommodation space being located on the side of the second surface of the frame body;
wherein the patch antenna is capable of transmitting and receiving the radiation signals.

4. The electronic device according to claim 1, wherein:
the processing chip is configured to, in a first mode, control the frame antenna to transmit the radiation signals to the target device, receive the radiation signals sent by the target device through the frame antenna, and determine an angle of the target device relative to the electronic device based on the radiation signals received by the frame antenna.

5. The electronic device according to claim 3, wherein:
the processing chip is configured to, in a second mode, control the patch antenna to transmit the radiation signals to the target device, receive the radiation signals sent by the target device through the frame antenna and the patch antenna, and determine the angle of the target device relative to the electronic device based on the received radiation signals.

6. The electronic device according to claim 5, wherein:
in response to the electronic device satisfying a parallel condition with a horizontal plane, the processing chip is configured to, in the first mode, control the frame antenna to transmit the radiation signals to the target device, receive the radiation signals sent by the target device through the frame antenna, and determine the angle of the target device relative to the electronic device based on the radiation signals received by the frame antenna.

7. The electronic device according to claim 4, further comprising:
a sensor configured to detect motion of the electronic device;
wherein the processing chip is configured to determine the angle of the target device relative to the electronic device based on motion parameters obtained from the sensor, and based on the motion parameters and the distance between the electronic device and the target device.

8. The electronic device according to claim 7, wherein:
the processing chip is configured to determine coordinates of the electronic device at different positions based on the motion parameters, and determine the angle of the target device relative to the electronic device based on the coordinates and distances between the electronic device and the target device at different positions.

9. A control method of an electronic device, the electronic device including a frame body, a target member of the frame body being metal and used as a frame antenna, the frame antenna at least being capable of transmitting and receiving radiation signals of a target frequency band, a radiation space of the radiation signals transmitted by the frame antenna at least including a first radiation space located on one side of a first surface of the frame body and a second radiation space located on one side of a second surface of the frame body, the first surface and the second surface being non-intersecting, and the target member connecting the first surface and the second surface, the control method comprising:
communicating with a target device, and receiving radiation signals transmitted by the target device through the frame antenna; and
determining a distance between the target device and the electronic device based on the radiation signals.

10. The method according to claim 9, further comprising:
in a first mode, controlling the frame antenna to transmit the radiation signals to the target device, receiving the radiation signals sent by the target device through the frame antenna, and determining an angle of the target device relative to the electronic device based on the radiation signals received by the frame antenna.

11. The method according to claim 9, further comprising:
in a second mode, controlling a patch antenna to transmit the radiation signals to the target device, receiving the radiation signals sent by the target device through the frame antenna and the patch antenna, and determining the angle of the target device relative to the electronic device based on the received radiation signals.

12. The method according to claim 11, wherein:
in response to the electronic device satisfying a parallel condition with a horizontal plane, in the first mode, controlling the frame antenna to transmit the radiation signals to the target device, receiving the radiation signals sent by the target device through the frame antenna, and determining the angle of the target device relative to the electronic device based on the radiation signals received by the frame antenna.

13. The method according to claim 10, further comprising:
detecting motion of the electronic device; and
determining the angle of the target device relative to the electronic device based on motion parameters obtained from a sensor, and based on the motion parameters and the distance between the electronic device and the target device.

14. The method according to claim 13, further comprising:
determining coordinates of the electronic device at different positions based on the motion parameters, and determining the angle of the target device relative to the electronic device based on the coordinates and distances between the electronic device and the target device at different positions.
